(19) United States
(12) Patent Application Publication
(10) Pub. No.: US 2025/0356625 A1
(43) Pub. Date: Nov. 20, 2025

(54) USING SEMANTIC HIERARCHY TREES TO INCREASE THE ROBUSTNESS OF OPEN-VOCABULARY OBJECT DETECTION AND VOCABULARY ADAPTER

(71) Applicant: NAVER CORPORATION, Seongnam-si (KR)

(72) Inventors: Riccardo VOLPI, Borigo Verezzi (IT); Gabriela CSURKA KHEDARI, Meylan (FR); Tyler HAYES, Cheektowaga, NY (US); Mingxuan LIU, Trento (IT); Massimiliano MANCINI, Trento (IT); Elisa RICCI, Trento (IT)

(73) Assignee: NAVER CORPORATION, Seongnam-si (KR)

(21) Appl. No.: 19/171,817

(22) Filed: Apr. 7, 2025

Related U.S. Application Data
(60) Provisional application No. 63/648,243, filed on May 16, 2024.

(51) Int. Cl. G06V 10/764; B25J 9/12; G06F 40/247; G06F 40/253; G06V 10/25; G06V 10/70; G06V 10/74

(52) U.S. Cl. CPC G06V 10/764; B25J 9/12; G06F 40/247; G06F 40/253; G06V 10/25; G06V 10/761; G06V 10/768

(57) ABSTRACT

An object identification system includes: a category module configured to, for a category of a vocabulary of objects, retrieve a hierarchy including at least: a sub-category that is more specific than the category; and a super-category that is less specific than the category; a sentence module configured to generate a set of sentences for the category that describe the hierarchical relationship between sub-category, super-category, and the category; an encoder module configured to encode the sentences into encodings, respectively, for the category; an aggregator module configured to generate an aggregated encoding for the category by aggregating the encodings of the category; and an identification module configured to selectively identify an object included in a region of interest of an input image as being in the category based on a comparison of (a) an encoding of the region of interest and (b) the aggregated encoding for the category.

### CROSS-REFERENCE TO RELATED APPLICATIONS

This application claims the benefit of U.S. Provisional Application No. 63/648,243, filed on May 16, 2024. The entire disclosure of the application referenced above is incorporated herein by reference.

### FIELD

The present disclosure relates to robot systems and more particularly to systems and methods for open vocabulary object detection for robots.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, an object identification system includes: a category module configured to, for a category of a vocabulary of objects, retrieve a hierarchy including at least: a sub-category that is more specific than the category; and a super-category that is less specific than the category; a sentence module configured to generate a set of sentences for the category that describe the hierarchical relationship between sub-category, super-category, and the category; an encoder module configured to encode the sentences into encodings, respectively, for the category; an aggregator module configured to generate an aggregated encoding for the category by aggregating the encodings of the category; and an identification module configured to selectively identify an object included in a region of interest of an input image as being in the category based on a comparison of (a) an encoding of the region of interest and (b) the aggregated encoding for the category.

In further features, the hierarchy includes at least two sub-categories that are more specific than the category.

In further features, the hierarchy includes at least two super-categories that are less specific than the category.

In further features, the hierarchy further includes at least one sub sub-category that is more specific than the sub-category.

In further features, the sentence module is configured to generate the sentences and describe the hierarchical relationship between each sub-category, super-category, and the category using an Is-A connector.

In further features, the vocabulary is defined based on at least one of user input and input received in response to querying a large language model.

In further features, the aggregator module is configured to generate the aggregated encoding for the category using a mathematical mean of the encodings.

In further features, the encoder module is configured to encode the sentences using a visual language model (VLM) text encoder.

In further features, the aggregator module is configured to generate the aggregated encoding for the category using a principal eigenvector.

In further features: the category module is further configured to, for a second category of the vocabulary of objects, determine a second hierarchy including at least: a second sub-category that is more specific than the second category; and a second super-category that is less specific than the second category; the sentence module is further configured to generate a second set of sentences for the second category that describe the hierarchical relationship between second sub-category, second super-category, and the second category; the encoder module is further configured to encode the second sentences into second encodings, respectively, for the second category; the aggregator module is further configured to generate a second aggregated encoding for the second category by aggregating the second encodings of the second category; and the identification module is further configured to selectively identify the object included in the region of interest of the input image as being in the second category based on a comparison of (a) the encoding of the region of interest and (b) the second aggregated encoding for the second category.

In further features, the identification module is further configured to: generate a first similarity score for the category based on a comparison of (a) the encoding of the region of interest and (b) the aggregated encoding for the category; and generate a second similarity score for the second category based on a comparison of (a) the encoding of the region of interest and (b) the second aggregated encoding for the second category; and determine whether to identify the object included in the region of interest as being in the category or the second category based on the similarity scores.

In further features, the identification module is configured to identify the object included in the region of interest as being in the category when the first similarity score is greater than the second similarity score.

In further features, the identification module is configured to identify the object included in the region of interest as being in the second category when the second similarity score is greater than the first similarity score.

In further features, the identification module is configured to generate the first and second similarity scores using cosine similarity.

In further features, the identification module is configured to generate the first and second similarity scores using the dot product function.

In further features, the hierarchy is generated by querying a large language model (LLM).

In further features, the input image is the region of interest.

In a feature, a robot system includes: a camera that captures the input image; the object detection system; and a control module that selectively actuates an actuator of the robot based on the object being identified as in the category.

In further features, the actuator includes an electric motor.

In a feature, an object identification method includes: for a category of a vocabulary of objects, retrieving a hierarchy including at least: a sub-category that is more specific than the category; and a super-category that is less specific than the category; generating a set of sentences for the category that describe the hierarchical relationship between sub-category, super-category, and the category; encoding the sentences into encodings, respectively, for the category; generating an aggregated encoding for the category by aggregating the encodings of the category; and selectively identifying an object included in a region of interest of an input image as being in the category based on a comparison of (a) an encoding of the region of interest and (b) the aggregated encoding for the category.

In a feature, an object identification system includes: a means for, for a category of a vocabulary of objects, retrieving a hierarchy including at least: a sub-category that is more specific than the category; and a super-category that is less specific than the category; a means for generating a set of sentences for the category that describe the hierarchical relationship between sub-category, super-category, and the category; a means for encoding the sentences into encodings, respectively, for the category; a means for generating an aggregated encoding for the category by aggregating the encodings of the category; and a means for selectively identifying an object included in a region of interest of an input image as being in the category based on a comparison of (a) an encoding of the region of interest and (b) the aggregated encoding for the category.

In a feature, an object detection system includes: a vocabulary adapter module configured to: receive an image and a first set of classifications; determine a natural language description based on the image; extract grammatical nouns from the natural language description; select ones of the classifications of the first set based on the grammatical nouns; generate a second set of classifications: including the selected one of the classifications of the first set; and not including non-selected ones of the classifications of the first set; and an identification module configured to selectively identify an object included in a region of interest of the image using the second set of classifications.

In further features, the identification module is configured to identify the object included in the region of interest as being associated with one of the classifications of the second set based on a comparison of (a) an encoding of the region of interest and (b) an aggregated encoding for the one of the classifications of the second set.

In further features, the vocabulary adapter module is configured to select the ones of the classifications of the first set further based on the natural language description.

In further features, the vocabulary adapter module includes a description module configured to determine a natural language description based on the image, where the description module includes a visual language model (VLM) that generates the natural language description.

In further features, the vocabulary adapter module is configured to generate the second set of classifications further based on synonyms of the classifications of the first set.

In further features, the vocabulary adapter module includes a class selector module configured to select the top-k most similar ones of the classifications of the first set to the grammatical nouns based on text similarity; and select the top-k most similar ones of the classifications of the first set as the classifications of the second set of classifications.

In further features, the vocabulary adapter module includes a large language model (LLM) configured to generate the second set of classifications.

In further features, the LLM is configured to generate the second set of classifications further based on synonyms of the classifications of the first set.

In further features, the LLM is configured to generate the second set of classifications further based on a prompt to identify and list every object visible in the image including both a foreground of the image and a background of the image.

In further features, the second set of classifications includes a few number of classifications than the first set of classifications.

In a feature, an object detection method includes: receiving an image and a first set of classifications; determining a natural language description based on the image; extracting grammatical nouns from the natural language description; selecting ones of the classifications of the first set based on the grammatical nouns; generating a second set of classifications: including the selected one of the classifications of the first set; and not including non-selected ones of the classifications of the first set; and selectively identifying an object included in a region of interest of the image using the second set of classifications.

In further features, the identifying the object includes identifying the object included in the region of interest as being associated with one of the classifications of the second set based on a comparison of (a) an encoding of the region of interest and (b) an aggregated encoding for the one of the classifications of the second set.

In further features, the selecting includes selecting the ones of the classifications of the first set further based on the natural language description.

In further features, the method further includes determining a natural language description based on the image using a visual language model (VLM).

In further features, generating the second set of classifications includes generating the second set of classifications further based on synonyms of the classifications of the first set.

In further features, the method further includes: selecting the top-k most similar ones of the classifications of the first set to the grammatical nouns based on text similarity; and selecting the top-k most similar ones of the classifications of the first set as the classifications of the second set of classifications.

In further features, the generating includes selecting the second set of classifications using a large language model (LLM).

In further features, the generating includes the LLM generating the second set of classifications further based on synonyms of the classifications of the first set.

In further features, the generating includes LLM generating the second set of classifications further based on a prompt to identify and list every object visible in the image including both a foreground of the image and a background of the image.

In further features, the second set of classifications includes a few number of classifications than the first set of classifications.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIGS. 1 and 2 are functional block diagrams of example robots;

FIGS. 3 and 4 are a functional block diagram of an example implementation of the object detection module;

FIG. 5 includes an example illustration comparing use of simply encodings of the categories (words) on the left and aggregated encodings (hierarchy aware sentences) on the right;

FIG. 6 is a flowchart depicting an example method of generating the aggregated encodings for use in object detection;

FIG. 7 is a flowchart depicting an example method of determining a category of a detected object;

FIG. 8 illustrates examples where a target class of interest is linked to a unique super-category at each higher hierarchical level and multiple sub-categories at each lower level and to two supercategories at a hierarchical level;

FIGS. 9 and 10 include example pseudo code for the concepts described;

FIG. 11 includes example block diagrams of object detection systems, where the lower portion includes a functional block diagram of an example object detection system including a vocabulary adapter module;

FIG. 12 includes a functional block diagram of an example object detection system and example implementations of a class selector module;

FIG. 13 includes an example input image and a query to list all primary and secondary objects in the image;

FIG. 14 includes a functional block diagram of an example implementation of a vocabulary adapter module;

FIG. 15 includes an example image with a predicted bounding box and a ground truth bounding box around an object;

FIG. 16 includes example prompts to a description module to describe the image;

FIG. 17 includes an illustration of a complete system and customer prompts used for the LLM-based example of the class selector module; and

FIG. 18 includes a flowchart depicting an example method of performing object detection and generating an adapted vocabulary.

In the drawings, reference numbers may be reused to identify similar and/or identical elements.

### DETAILED DESCRIPTION

A robot may include a camera. Images from the camera and measurements from other sensors of the robot can be used to identify objects captured in the images. One or more actions may be taken based on an identified object. For example, a control module may, based on the detection of one or more objects, control actuation of the robot, such as propulsion, actuation of one or more arms, and/or actuation of a gripper.

Open-vocabulary object detection (OvOD) has transformed object detection into a language-guided task, empowering users to freely define their class vocabularies of interest during inference. However, existing OvOD detectors exhibit significant variability when dealing with vocabularies across various semantic granularities, posing a concern for real-world deployment.

The present application details a OvOD model including a classifier that uses semantic knowledge from class hierarchies. The model retrieves relevant super-/sub-categories from a hierarchy for each target class in a given vocabulary. The model integrates these categories into hierarchy-aware sentences for each class. The model fuses (e.g., aggregates) these sentence embeddings to generate a nexus classifier vector (one for each class). Given an image, the model determines the class of the objects in the image by using the nexus classifier vectors.

The model enhances robustness across diverse vocabulary granularities, while retaining improvements using hierarchies generated by large language models. When applied to open-vocabulary classification, the model described herein improves zero-shot baseline accuracy. The model is not trained and can be used with an off-the-shelf OvOD detector, without incurring extra computational overhead during inference.

OvOD transforms the object detection task into a language guided matching problem between visual regions of interest in images and class names. Leveraging weak supervisory signals and a prealigned vision-language space from Vision-Language Models (VLMs), OvOD methods extend the ability to localize and categorize objects beyond the trained categories. Under OvOD, target object classes are described using text prompts like “a {Class Name}”, rather than class indices. By altering the “{Class Name}”, OvOD enables freely definition of Classes of Interests (CoIs) using natural language. This allows new classes of interest to be detected without the need for model re-training.

OvOD however may be sensitive to the choice of vocabulary. For example, performance of a model may be improved by substituting scientific CoI names, like “Rosa”, with common English language names, such as “Rose”. OvOD may be improved by better aligning object features with the VLM semantic space.

In practical scenarios, CoIs are in the eyes of the beholder. For example, consider a region of interest (crop) of a “Dog”: one may be interested in the specific breed (e.g., “Labrador”), while another might only be concerned about whether it is an “Animal”. Thus, the CoI is defined at varying levels of semantic granularity. Ideally, since these CoIs refer to the same visual region, the performance of an OvOD detector should be consistent across different granularities. However, performance of an OvOD detector may fluctuate based on the vocabulary granularity. This inconsistency in performance across granularities may pose questions, such as in instances like autonomous driving. Although the same physical object, a “Labrador”, can be classified at varying levels of granularity, the inherent fact that a “Labrador is a dog, which is an animal” remains constant.

The present application provides this via a semantic hierarchy. The present application enhances the robustness of an OvOD detector to vocabularies specified at any granularity by leveraging knowledge in semantic hierarchies. Super-/sub-categories of CoIs from hierarchies are used to improve accuracy. The present application does not involve searching through the sub-categories or the super categories at inference time, leading to substantial computational power decrease and improves usability in object detection.

The model described herein enhances robustness of OvOD to diverse vocabulary granularities. The concepts described herein do not involve additional training (they are “training-free”), and ensure that the inference procedure is linear in complexity relative to the number of CoIs. The model first retrieves relevant super(abstract)-/sub(specific)-categories from a semantic hierarchy for each CoI in a vocabulary. The model then uses an Is-A connector to integrate these categories into hierarchy-aware sentences, while explicitly modeling their internal relationships. The model encodes these hierarchy-aware sentences. The model fuses these text embeddings into a vector, termed nexus, such as using an aggregator (e.g., the mathematical mean operation) to form a classifier weight for the target CoI.

The present application also involves a vocabulary adapter. Open-vocabulary object detection models enable users to freely specify a class vocabulary in natural language at test time, guiding the detection of desired objects.

However, vocabularies can be overly broad or even mis-specified, hampering the overall performance of the detector. The present application involves a plug-and-play Vocabulary Adapter (VocAda) to refine the user-defined vocabulary, automatically tailoring it to categories that are relevant for a given image. VocAda operates at the inference stage, in parallel with the object detector, and: i) uses an image captioner to generate textual descriptions of the visible objects in the input image, ii) extracts category names from the captions via noun parsing, and iii) uses the extracted nouns and generated descriptions to select relevant classes from the user-defined vocabulary, discarding irrelevant ones. The vocabulary adapter does not require any training, and allows the detector to focus on relevant classes by actively ignoring the distracting ones. The vocabulary adapter provides performance gains during inference across object detectors and highlights its model-agnostic nature.

Object detection is a visual perception task aimed involving determining classifications of visible objects in the image and locating them. This involves accurately predicting bounding boxes around the visible objects and assigning the correct class labels to them. The information resulting from object detection has multiple use cases/applications, including autonomous vehicle driving, robotic actuation, embodied artificial intelligence (AI), and others.

Object detectors may only be able to recognize object classes that were present in the training data upon which they were trained. This constraint necessitates retraining the model whenever a new object class of interest appears.

To address this, open-vocabulary object detection (OvOD) involving contrastive vision-language models (VLMs) may be used. By projecting both visual and textual representations (of input images and text for the classes) into a joint space, contrastive VLMs enable the alignment of the OvOD detector's bounding box embeddings (visual) with object class name embeddings (textual) when training the detector. This alignment allows OvOD models enable end users with the possibility of tailoring the detector vocabulary to their specific interests or applications.

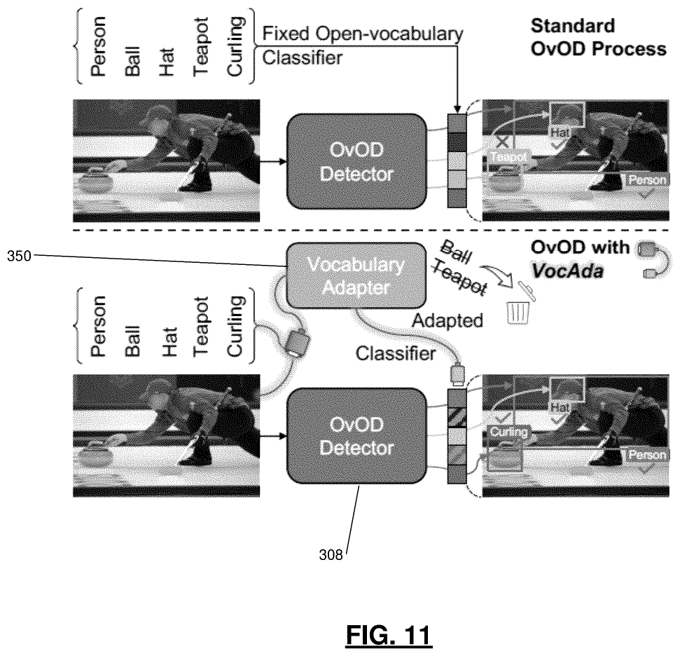

These user-defined object-centric vocabularies (e.g., sentences pointing to specific objects) can be combined with OvOD detectors to identify visual objects in images in a zero-shot manner, without any retraining. While the OvOD paradigm allows users to detect concepts at deployment time, defining a vocabulary with a broad set of classes can introduce noise during inference, potentially jeopardizing detector performance. For example, a OvOD detector may mis-detect a “Curling” stone as a “Teapot”, as illustrated in FIG. 11 due to their visual similarity. This may occur because an OvOD detector may rank classes primarily based on individual region class similarity, without explicitly interpreting the image context to guide class assignment. A model that understands the whole scene will most likely not classify sports equipment as a “Teapot”. FIG. 11 includes example block diagrams of object detection systems. The lower portion of FIG. 11 includes a functional block diagram of an example object detection system including a vocabulary adapter module.

According to the present application, the vocabulary adapter module (VocAda) is training free and designed to improve the performance of OvOD detectors. The vocabulary adapter module adapts the user-defined vocabulary to the current image input based on the interpretation of the image's semantic context at inference time. As shown in FIG. 11, the vocabulary adapter constrains the user-defined vocabulary to categories relevant to the image content. The OvOD detector's classifier (e.g., the identification module 308 assigning classes to the detected regions) will then select classes only from the refined vocabulary, excluding distractor classes.

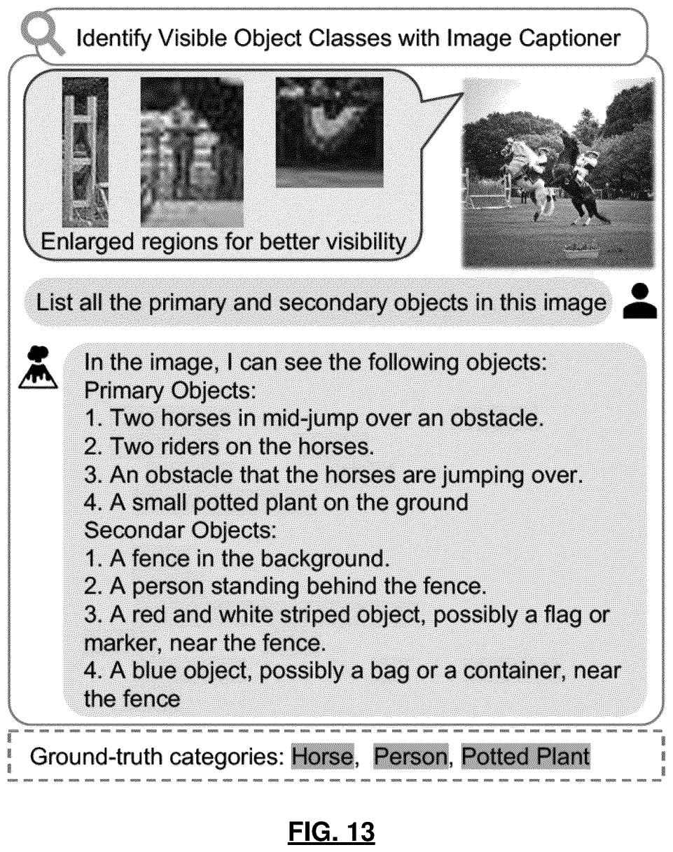

The vocabulary adapter module accurately identifies classes that are both of interest to the user and present in the image (e.g., relevant to the image, for example, a teapot is not relevant to the sporting situation in the image of FIG. 11). The vocabulary adapter module first generates descriptions of input images. The vocabular adapter module then extracts class names via noun parsing. While effective, there may be a discrepancy between the extracted noun phrases and the user-defined classes (e.g., “Riders” vs. “Person” in FIG. 13). To bridge this gap and identify classes of interest to the user within the extracted-noun vocabulary, the present application provides two examples of class selector modules: one example uses text similarity scores between the noun phrases and the vocabulary classes, and the other example uses a large language model (LLM) to automatically propose classes from the vocabulary based on the input noun phrases and the full image description.

The vocabulary adapter module can be integrated with any OvOD model and operates in parallel with the detector, minimizing the computational overhead introduced by large VLMs. The vocabulary adapter module consistently offers notable improvements across various benchmarks and detectors. There is a need for an image dependent vocabulary in OvOD, and an optimal vocabulary (oracle) yields significant improvements. The vocabulary adapter module is OvOD model-agnostic and provides a training-free method for vocabulary adaptation in OvOD. The vocabulary adapter module improves OvOD detectors without any fine-tuning by modifying only their vocabulary.

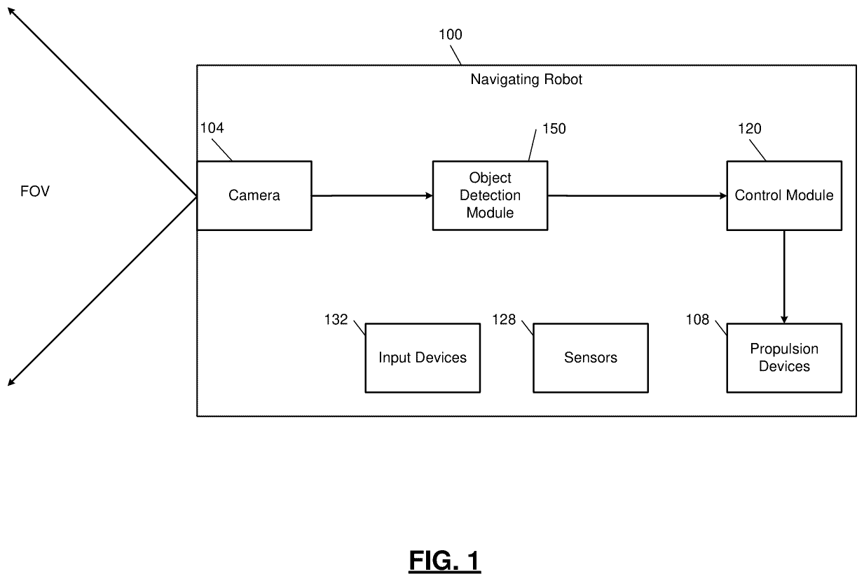

FIG. 1 is a functional block diagram of an example implementation of a navigating robot 100. The navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces. In various implementations, the camera 104 may be a binocular camera, or two or more cameras may be included in the navigating robot 100.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The navigating robot 100 is powered, such as via an internal battery and/or via an external power source, such as wirelessly (e.g., inductively).

While the example of a navigating robot is provided, the present application is also applicable to other types of robots with a camera.

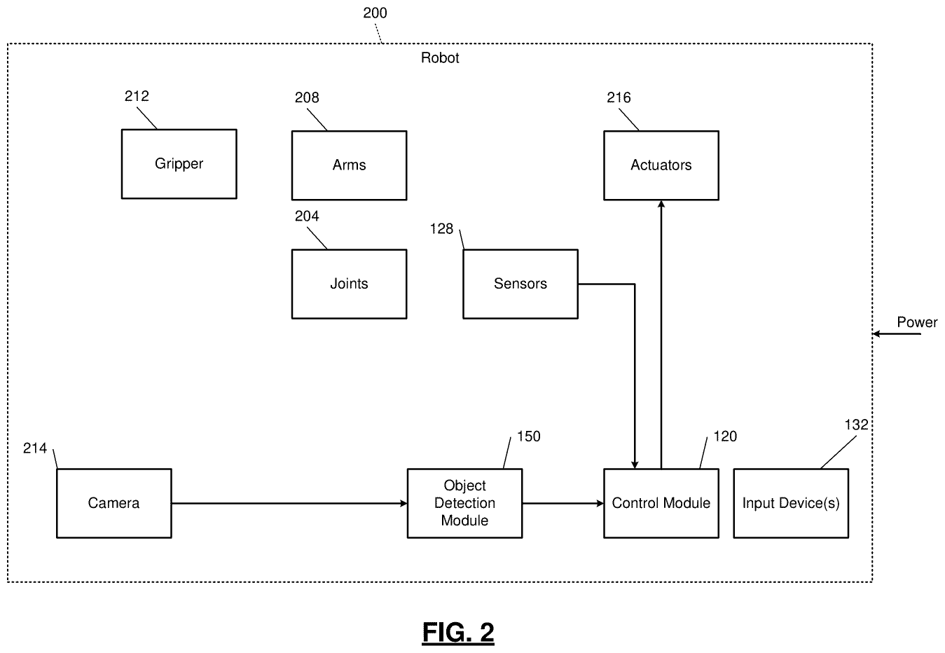

For example, FIG. 2 includes a functional block diagram of an example robot 200. The robot 200 may be stationary or mobile. The robot 200 may be, for example, a 5 degree-of-freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini cheetah robot, or another suitable type of robot. The robot 200 may be a humanoid robot in various implementations.

The robot 200 is electrically powered, such as via an internal battery and/or via an external power source, such as alternating current (AC) power. AC power may be received via an outlet, a direct cabled connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi-fingered) gripper 212 of the robot 200. The robot 200 includes actuators 216 that actuate the arms 208 and the gripper 212. The actuators 216 may include, for example, electric motors and other types of actuation devices.

In the example of FIG. 1, a control module 120 controls actuation of the propulsion devices 108. In the example of FIG. 2, the control module 120 controls the actuators 216 and therefore the actuation (movement, articulation, actuation of the gripper 212, etc.) of the robot 200. The control module 120 may include a planner module configured to plan movement of the robot 200 to perform one or more different tasks. An example of a task includes moving to and grasping and moving an object. The present application, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency. In various implementations, the camera 214 may be a binocular camera, or two or more cameras may be included in the robot 200.

The control module 120 controls actuation of the robot based on one or more images from the camera. The control module 120 may control actuation additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, a microphone, and/or one or more other suitable types of input devices.

For example, the control module 120 may control actuation of the robot based on one or more objects detected by an object detection module 150. The object detection module 150 detects objects in images as discussed further below.

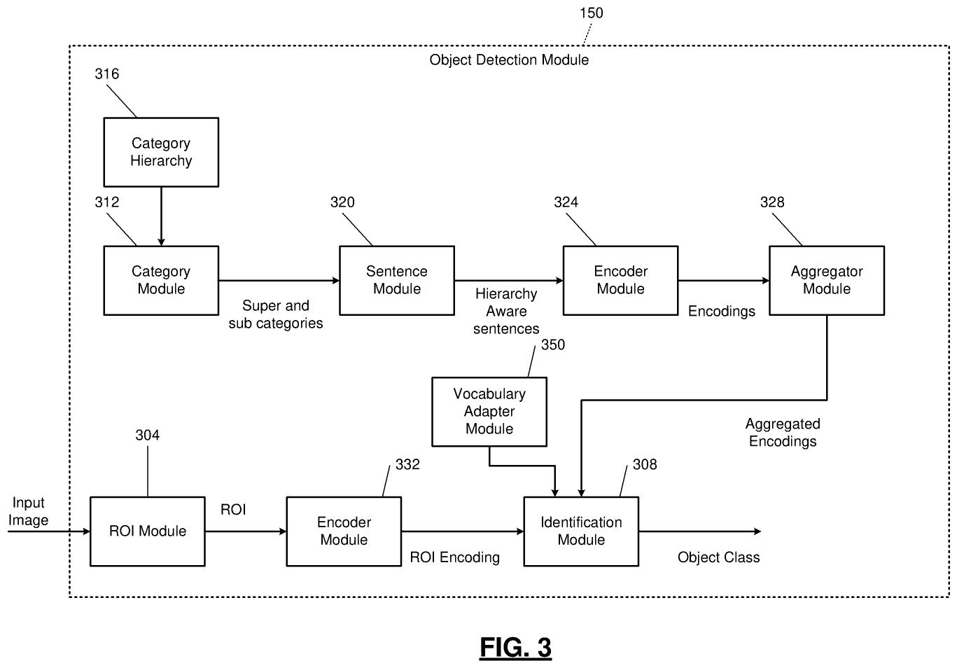

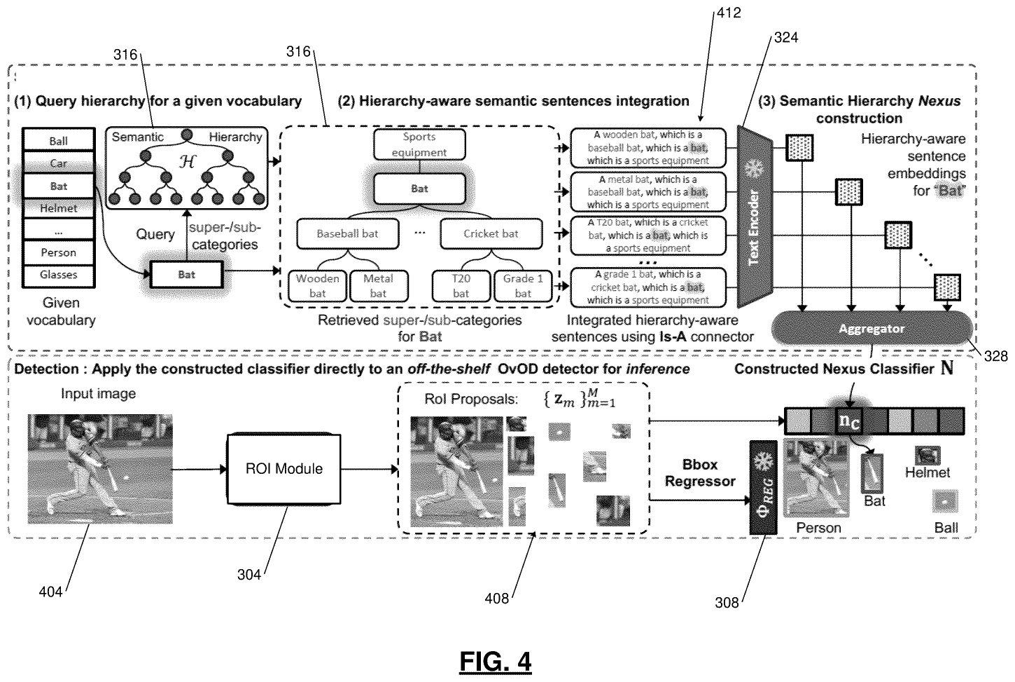

FIGS. 3 and 4 are a functional block diagram of an example implementation of the object detection module 150. A region of interest (ROI) module 304 receives an image (e.g., from a camera of the robot). The ROI module 304 detects an object in the image and determines pixel coordinates defining ROI of the image including (e.g., a rectangular box) the object. The ROI module 304 may do this for each object detected in the image. An image is illustrated by 404 in FIG. 4, and example ROIs, respectively, are illustrated by 408 in FIG. 4. As illustrated, each ROI includes an area (e.g., a crop) of the input image including a detected object.

An identification module 308 determines a label (e.g., name, class) for an object in the ROI using object classification as discussed further below. The identification module 308 determines a label for each ROI (for each object detected).

A category module 312 queries a category hierarchy 316 with a category of an object to determine super and subcategories associated with the category. In other words, the category module 312 determines super and subcategories associated with the category based on the category using the category hierarchy 316. A super category of a category may be a category that is broader (more general) than the category itself. For example, a super-category of the category “bat” may be “sports equipment” as illustrated in the example of FIG. 4 as a bat is one type (of many different types) of sports equipment. One or more super-categories of a super category may be included. A sub-category of a category may be a category that is narrower (more specific) than the category. For example, sub-categories of the category “bat” may be “baseball bat” and “cricket bat” as illustrated in the example of FIG. 4 as cricket bats and baseball bats are different types of bats. One or more sub-categories of a sub-category may be included. For example, sub-categories of the sub-category “baseball bat” may be “wooden bat” and “metal bat” as illustrated in the example of FIG. 4 as metal bats and wooden bats are different types of baseball bats.

For a lowest level of sub-category in the hierarchy, a sentence module 320 generates a hierarchy aware sentence that includes the category and the super and sub-categories retrieved. The sentence module 320 does this for each lowest level sub-category.

In the example of FIG. 4, four sub-categories are retrieved and four sentences are generated. Example sentences are illustrated by 412. For the example sub- sub-category “wooden bat” under the sub-category “baseball bat” of the category “bat” and the super-category “sports equipment,” an example sentence may be “a wooden bat, which is a baseball bat, which is a bat, which is sports equipment.” Thus, the sentence includes the category and each super and sub-category, and describes the relationship between each level in the hierarchy. The sentence module 320 generates a sentence for each of the lowest-level sub-categories retrieved. Thus, each lowest level sub-category has a sentence generated for it that includes the sub-category(ies), the category, and the super-category of the hierarchy.

An encoder module 324 encodes the hierarchy aware sentence into an encoding using a text encoder. The encoder module 324 does this for each hierarchy aware sentence. The encodings may be, for example, vectors of a predetermined length.

An aggregator module 328 aggregates the encodings of a category to produce an aggregated encoding, which may be referred to as a nexus classifier N for the category. In other words, the aggregator module 328 generates the aggregated encoding for the category based on the encodings. In the example of FIG. 4, the aggregator module 328 aggregates the four sentence encodings of the category bat to generate an aggregated encoding for bats. For example, the aggregator module 328 may set the entries of the aggregated encoding (vector) based on or equal to mathematical averages of the respective entries of the encodings of the category. As an example, the aggregator module 328 may set a first entry in the aggregated encoding based on or equal to a mathematical average (sum divided by the total number of first entries) of the first entries of the encodings.

The aggregated encodings for each category are stored for use to identify and classify objects in ROIs in images.

For example, as discussed above the ROI module 304 determines a ROI of an in input image that includes an object. An encoder module 332 encodes the ROI into an ROI encoding using an image encoder, such as the CLIP image encoder. The CLIP image encoder is described in A. Radford, et al., Learning transferrable visual models from natural language supervision, in ICML, 2021, which is incorporated herein in its entirety. The ROI encoding may be a vector having the same length as the aggregated encodings. The encoder module 332 may generate an ROI encoding for each ROI based on that ROI of the input image using the image encoder.

The identification module 308 determines similarity scores (e.g., values) for the categories based on comparisons of (a) the respective aggregated encoding for that category (nexus classifier vector) and (b) the ROI encoding. For example, the identification module 308 determines a similarity score for the category bat based on the aggregated encoding for the category bat and the ROI encoding. The identification module 308 determines a similarity score for the category helmet based on the aggregated encoding for the category helmet and the ROI encoding, and so on. The identification module 308 determines a similarity score for each category. In various implementations, the similarity scores may be values between 0 and 1 where 0 is dissimilar and 1 is complete similarity. The present application, however, is also applicable to other values. The similarity score may increase as similarity between the ROI encoding and the aggregated encoding increases and vice versa. The identification module 308 may determine the similarity score for a category, for example, based on a dot product of the aggregated encoding and the ROI encoding.

The identification module 308 determines one of the categories for the object in the ROI based on the similarity scores. For example, the identification module 308 may select the one of the categories with the highest similarity score as the classification for the object in the ROI. As such, the identification module 308 identifies the object in the ROI as the category with the highest similarity score between the aggregated encoding for that category and the ROI encoding for the ROI including the object. The identification module 308 does this for each ROI thereby determining a category for each object/ROI. One or more actions may be taken by the control module 120 based on the category of an object. For example, the control module 120 may actuate one of the actuators and/or propulsion devices of the robot based on the category of an object.

To summarize FIG. 4, the present application involves constructing semantic hierarchy nexus classifiers offline. For each classification (category, e.g., “bat” in green) in a vocabulary of classifications for objects (vocabulary including classifications), super (blue) and sub (pink) categories are determined (e.g., retrieved) from a semantic hierarchy, The categories along with their interrelationships are integrated into a set of hierarchy aware sentences for the category, such as using an IS-a connector. The sentences are encoded, such as by a VLM text encoder such as the CLIP text encoder. The CLIP text encoder is described in A. Radford, et al., Learning transferrable visual models from natural language supervision, in ICML, 2021, which is incorporated herein in its entirety. The encodings are fused together using an aggregator (e.g., a mean aggregator or a principal eigenvector aggregator) to form the nexus classifier vector for the classification. This is done for each classification in the vocabulary. The vectors are used to classify objects in ROIs detected in input images improving performance.

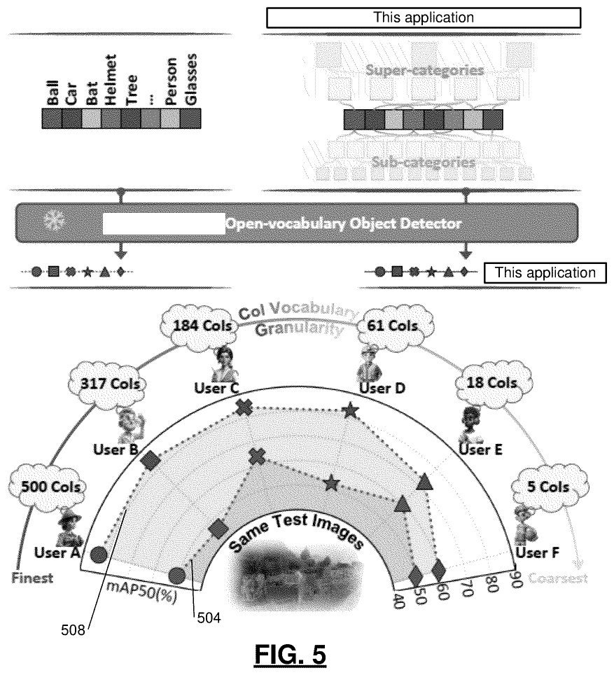

FIG. 5 includes an example illustration comparing use of simply encodings of the categories (words) on the left and aggregated encodings (hierarchy aware sentences) on the right. The bottom of FIG. 5 illustrates open vocabulary object detection performance at different levels of vocabulary granularity. Inner trace 504 illustrates performance based on the encodings of the categories and underperforms the performance of outer trace 508 for use of the aggregated encodings. The inner trace 504 presence significant variability across different levels of vocabulary granularity. Outer trace 508 for the concepts of the present application shows improved performance and less variability.

An objective is to improve the robustness of object detectors to diverse and user defined (in the vocabulary classes of interest (CoIs) with varying levels of semantic granularity. The concepts described herein can be integrated with trained OvOD detectors in a zero shot manner.

An OvOD detector localizes and classifies object classes specified in a vocabulary (e.g., user defined) in a zero-shot manner without necessitating re-training. Given an input image I∈ [symbol] ^{3xhxw}, an OvOD localizes all foreground objects and classifies them by estimating a set of bounding box coordinates and class label pairs {bₘ, cₘ}_{Mm=1} where bₘ∈R₄. cₘ∈Cₜₑₛₜ is a class label allocated from the vocabulary set Cₜₑₛₜ at test time. To attain open-vocabulary capabilities, an OvOD may use a box-labeled dataset D_{det} with a limited vocabulary C_{det} and an auxiliary dataset D_{weak} as weak supervisory signals with coarser image-class or image-caption annotation pairs but an extensive vocabulary C_{weak} to significantly broaden its detection vocabulary.

Examples of OvOD detectors that could be used include Detic and VLDet. Detic is described in X. Zouh, et al., detecting twenty-thousand classes using image-level supervision, in ECCV, 2022, which is incorporated herein in its entirety. VLDet is described in W. Lin, et al., Match, expand and improve: Unsupervised finetuning for zero-shot action recognition with Language Knowledge, arXiv, 2023, which is incorporated herein in its entirety. OvOD detectors may follow a two-stage framework. First, given an image, a learned region proposal network (RPN) yields a bag of M region (ROI) proposals by {zₘ}_{Mm=1}=Φ_{RPN}(I), where zₘ∈R_{D} is a D-dimensional region-of-interest (Rol) feature embedding (ROI encoding). For each proposed region, a learned bounding box regressor (of the identification module 308) predicts the location coordinates by \hat{ }bₘ=Φ_{REG}(zₘ), while an open-vocabulary classifier (of the identification module 308) estimates a set of classification (similarity) scores sₘ(c, zₘ)= [symbol] w_{c}, zₘ [symbol] for each class, where w_{c} is a vector in the classifier W∈R_{|c}_{ₜₑₛₜ}_{|·} [symbol] ⋅, ⋅ [symbol] is a cosine similarity function. W is the frozen text classifier, created by using a VLM text encoder (e.g., CLIP) to encode the names of CoIs in Cₜₑₛₜ specified in the vocabulary. The CoI that yields the highest score is assigned as the classification result (by the identification module 308).

OvOD detectors learn during pre-training all model parameters except for the frozen text classifier. This allows them to achieve region-class alignment by leveraging the vision-language semantic space pre-aligned by VLMs for the open-vocabulary capability.

The classifier (of the identification module 308) described herein improves OvOD. As illustrated in the top of FIG. 4, for each target CoI c∈Cₜₑₛₜ (e.g., “Bat”) in the vocabulary, constructed is a nexus point n_{c}∈R_{D} by conveying information from related super-/sub-categories derived from the semantic category hierarchy H 316. Upon constructing the nexus point for each category offline, the based classifier (of the identification module 308) N is directly applied to an OvOD detector for inference and object classification. This enables the classification score sₘ(c, zₘ)= [symbol] n_{c}, zₘ [symbol] to be high when the proposed region closely aligns with the semantic hierarchy “theme” embodied by the nexus point, which represents the fusion of a set of hierarchy-aware semantic sentences from specific to abstract that are relevant to the CoI c.

To obtain related super-/sub-categories, the semantic category hierarchy H 316 is used. The hierarchy 316 may be, for example, (i) a dataset-specific class taxonomy hierarchy or (ii) a hierarchy synthesized for the vocabulary using a large language models (LLM). For example, to generate the hierarchy 316 a LLM may be queried to generate a predetermined number p (e.g., 3) super-categories for each category and a predetermined number q (e.g., q=10) subcategories for each category (CoI) CoI c∈Cₜₑₛₜ, creating a three-level hierarchy H. With the hierarchy available, as depicted, for each target CoI c, the category module 312 may retrieve all associated super-/sub-categories, which can assist in distinguishing c from other concepts in the vocabulary across granularities. In various implementations, the root node (e.g., “entity”) may be omitted from this process, as it may not help differentiate c from other categories.

The collected categories include individual specific and abstract semantics useful for guiding the classification process. However, methods like simple ensembling or concatenation may overlook some valuable knowledge implicitly provided by the hierarchy. An Is-A connector (X is a Y) may be used to relate categories, subcategories, and super-categories, although other connectors may be used to construct the sentences. For each target CoI c, the Is-A connector integrates into sentences the retrieved categories, from the lowest sub-category (more specific) to the highest super-category (more abstract), including the target CoI name. This process yields a set of K hierarchy-aware sentences {eₖ^{c}}ₖ₌₁^{k}. Each sentence e_{ck} includes knowledge that spans from specific to abstract, all related to the target CoI and captures their inherent relationships, such as “A wooden baseball bat, which is a baseball bat, which is a bat, which is a sports equipment” where the sub-categories, target category, and super-categories are included.

A nexus n_{c}∈R_{D} serves as a unifying embedding that fuses the hierarchy aware knowledge contained in the integrated sentences {e_{ck}}_{Kk=1}. A frozen VLM text encoder may be used Eₜₓₜ to translate the integrated sentences into the region-language aligned semantic space compatible with the OvOD detector. The semantic hierarchy nexus for the CoI c is then constructed by aggregating these individual sentence embeddings as

$${n}_{c} = Aggregator ( \{ {ℰ}_{txt} {\{ {e}_{k}^{c} \}}_{k = 1}^{k} \} ) \qquad ( 1 )$$

where a mean aggregator may be used to compute the mean vector of the set of sentence embeddings. A goal of the aggregation process is to fuse the expressive and granularity robust knowledge into the nexus vector as a “theme”, from the encoded hierarchy-aware sentences. Alternatively, the aggregator module 328 may perform SVD decomposition of the sentence embeddings and replace the mean vector with the principal eigenvector as n_{c}. As shown in the bottom of FIG. 4, after the nexus points (vectors) are determined for each CoI in the target vocabulary, object detection can be performed during inference, involving assigning class (category) names to the proposed regions as:

$${\hat{c}}_{m} = arg {max}_{c ∈ {C}^{T e s t}} 〈 {n}_{c} , {z}_{m} 〉 \qquad ( 2 )$$

where zₘ is the m-th region embedding. Given that n_{c}∈R_{D}, it becomes evident from equation 2 that the same computational complexity is used when using the aggregated encodings. While the present application is discussed in terms of object detection, the present application is also applicable to open-vocabulary classification by substituting the region embedding zₘ with an image one, namely one extracted by encoding a full image with the encoder module 332, without any ROI module 304.

In various implementations, the hierarchy 316 may be provided, such as to allow a straightforward retrieval of the super and subcategories. As discussed above, however, the hierarchy 316 or some of the super and subcategories may be generated, for example, using a LLM. Given a label vocabulary Cₜₑₛₜ representing the target CoIs (including the vocabulary of categories) at a specific granularity level of the evaluation dataset, the true super-/sub-categories for each CoI may be unknown. To generate a 3-level hierarchy for Cₜₑₛₜ, we an LLM may be queried to generate a list of super-categories for each CoI c∈Cₜₑₛₜ using the super category prompt, such as follows:
Generate a list of p super-categories that the following [context] object belongs to and output the list separated by ‘&’: c here p=3.

Subsequently, for each CoI c∈Cₜₑₛₜ, the LLM may be queried again to generate a list of sub-categories using the sub-category prompt, such as follows:
Generate a list of q types of the following [context] and output the list separated by ‘&’: c where q=10.

The [context] prompt may be consistently set to object across all datasets. The ‘&’ symbol serves as a separator prompt, facilitating the formatting of the LLMs responses for easier post-parsing of category names. The final lists of super-categories and sub-categories may be the union of results from t=3 LLM queries. To be more specific, the same super-/sub-category prompts may be used to query the LLM t=3 times for each target CoI, and then these LLM responses may be amalgamated to form the final results/hierarchies. In order to generate hierarchies for all datasets, p=3, q=10, and t=3, however other values may be used.

As a result of merging and de-duplicating the generated category names from multiple LLM queries, the hierarchy may not include a predetermined (fixed) number of super-/sub-categories for each target CoI (class). Thus, the hierarchy 316 may be more varied and imbalanced, aligning more closely with real-world scenarios.

Regarding the setting of p=3, in real world contexts, there is no single “optimal” hierarchy for any given vocabulary set. A single vocabulary can have multiple, equally valid hierarchical arrangements, depending on the categorization principles applied. For example, “Vegetable salad” might be classified under various super-categories-such as “Appetizer”, “Cold dish”, “Side dish”, or simply “Vegetable”-based on cultural or contextual differences. Therefore, a truly robust and effective hierarchy-based method should function with hierarchies open to diverse categorization principles. In such open hierarchies, categories are open to multiple categorization principles (i.e., one class may link to several super category nodes). Thus, p=3 super categories per target CoI (category) in Ctest may be used at each single LLM query. In our 3-level synthetic hierarchies, each target CoI falls under multiple super-categories generated from three times of LLM queries, reflecting various and diverse categorization principles. This approach allows rigorously evaluation of the efficacy of the systems and methods described herein in realistic, diverse yet noisy categorization scenarios.

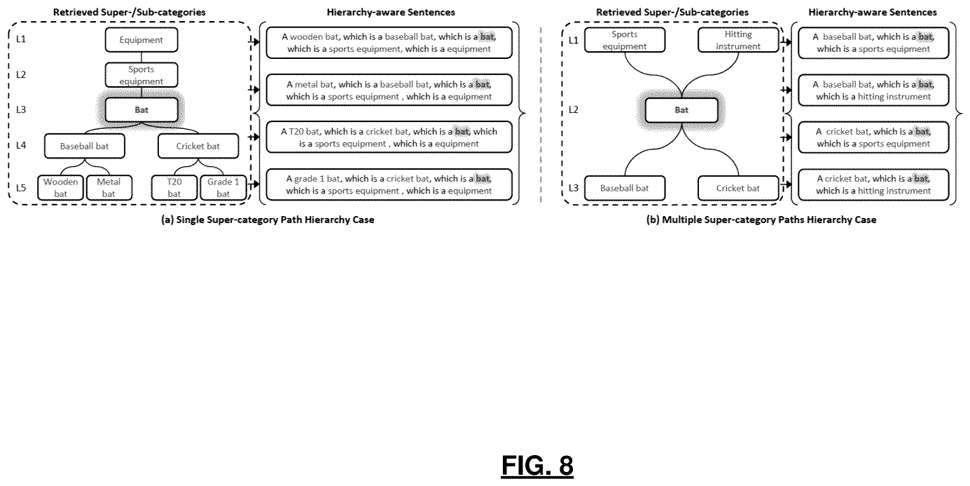

FIG. 8 illustrates the case where the target Class of Interests (CoI) is linked to a unique super-category at each higher hierarchical level and multiple sub-categories at each lower level. In this case, the Is-A connector may be used to form hierarchy-aware sentences by integrating the lowest linked sub-category, the target CoI, and the highest super-category, following their hierarchical relationships in a bottom-up manner. As a result, the total number of constructed sentences in this case equals the number of the lowest linked sub-categories.

The right side of FIG. 8 illustrates the example of multiple super-category path hierarchy case where the target CoI is linked to multiple super-categories at the upper level and several sub-categories at the lower level. Here, the hierarchy-aware sentences may be generated by the sentence module 320 by iterating through all combinations of the linked sub-categories, super-categories, and the target CoI. The Is-A connector is used to connect these categories in a specific-to-abstract order. The resulting number of constructed sentences in this case equals the product of the counts of the lowest linked sub-categories and the linked super-categories.

Regarding a mean aggregator, the mean aggregator can be described by:

$${n}_{c} = \frac{1}{K} {Σ}_{k = 1}^{K} {ℰ}_{txt} ( {e}_{k}^{c} ) \qquad ( 3 )$$

where εₜₓₜ is the frozen text encoder, and

$${\{ {e}_{k}^{c} \}}_{k = 1}^{K}$$

represents the K hierarchy-aware sentences, which are built by integrating all super-/sub-categories related to the target class (CoI) c using the Is-A connector. This aggregator may calculate the mean of the encoded sentences' embeddings to form the final nexus based classifier weight vector for c. This mean vector is the centroid represented within CLIP's embedding space, summarizing the general characteristics of the hierarchy-aware embeddings related to the target CoI. At inference, the classification decision for a region is based on the cosine similarity between the visual embedding of the region and the hierarchy-aware representation defined by the mean vector n, which may be referred to as the nexus (aggregated encoding).

This approach renders the decision-making process less sensitive to variations in the semantic granularity of the name c. Note that all the embeddings may be I2-normalized.

In various implementations, a principal eigenvector aggregator may be used. This uses the principal eigenvector of the sentence embeddings matrix as the classifier weight vector n_{c}. Specifically, for a set of hierarchy-aware sentences

$${\{ {e}_{k}^{c} \}}_{k = 1}^{K}$$

a Singular Vector Decomposition (SVD) operation may be performed by the aggregator module 328 on their embedding matrix as:

$$U S {V}^{T} = SVD ( {concat}_{k = 1}^{K} \{ {\{ {e}_{k}^{c} \}}_{k = 1}^{K} \} ) \qquad ( 4 )$$

where U and V are orthogonal matrices representing the left and right singular vectors, respectively, and S is a diagonal matrix with singular values in descending order. Subsequently, the principal eigenvector, corresponding to the largest singular value in the sentence embedding matrix may be determined by selecting the first column of matrix V as:

$${n}_{c} = V [ : , 0 ] \qquad ( 5 )$$

where n_{c} serves as the nexus-based classifier vector for the target class c. In contrast to the mean-aggregator, the principle eigenvector aggregator may capture a dominant trend in the sentence embeddings (the theme) to effectively represent the CoIs. All the embeddings may be I2-normalized.

In high-dimensional semantic spaces like a 512-dimensional vision-language aligned embedding space, the principal eigenvector may be able to capture the most significant semantic patterns or trends within the embeddings. This approach stems from the understanding that the direction of greatest variance in the space contains the most informative representation of semantic embeddings. Projecting the high-dimensional hierarchy-aware sentence embeddings of a target class (CoI) onto this principal eigenvector yields a condensed yet information-rich representation, preserving the essence of the original hierarchy-aware sentences. Consequently, during inference, classification decisions for a region are based on the cosine similarity between the region's embedding and the semantic pattern or trend depicted by the principal eigenvector. This differs from the representation centroid approach used by the mean-aggregator.

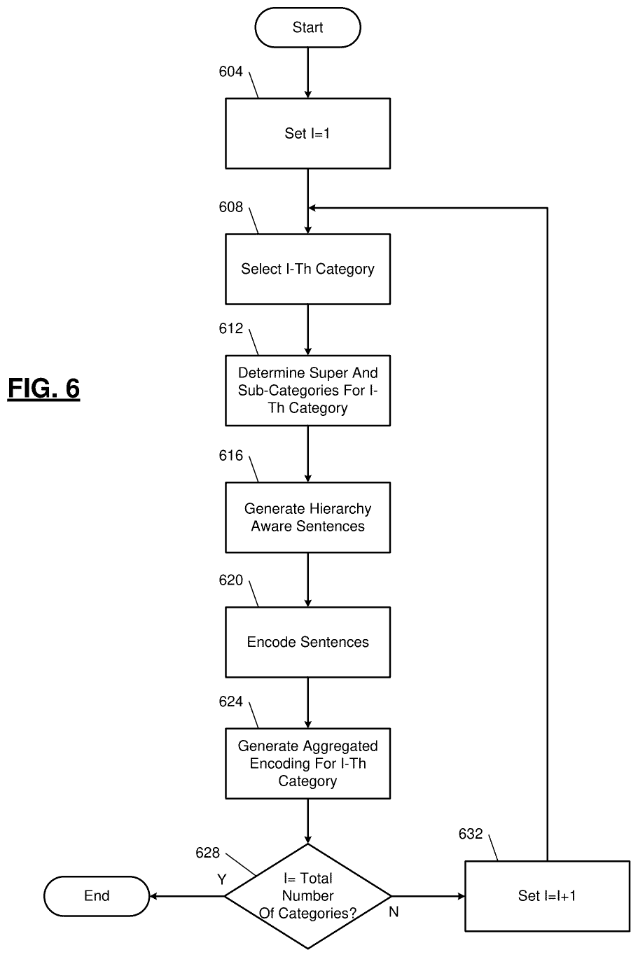

FIG. 6 is a flowchart depicting an example method of generating the aggregated encodings for use in object detection. Control begins with 604 where the category module 312 sets a counter value I equal to 1. At 608, the category module 312 selects the I-th category of the vocabulary. At 612, the category module 312 determines the super and subcategories of the I-th category from the category hierarchy 316. Examples are provided in FIG. 8. As illustrated, a category may have two or more different super categories in various implementations.

At 616, the sentence module 320 generates the hierarchy aware sentences for the i-th category. Example sentences are illustrated in FIG. 8.

At 620, the encoder module 324 encodes the hierarchy aware sentences using a text encoder (e.g., the CLIP text encoder) to generate a set of encodings for I-th category. At 624, the aggregator module 328 aggregates the encodings for the I-th category to produce an aggregated encoding for the I-th category.

At 628, the category module 312 may determine whether the counter value I is equal to a total number of categories included in the vocabulary. If 628 is true, control may end. If 628 is false, the category module 312 may increment the counter value I at 632 (e.g., set I=I+1), and control may return to 608 to generate an aggregated encoding for the next category in the vocabulary.

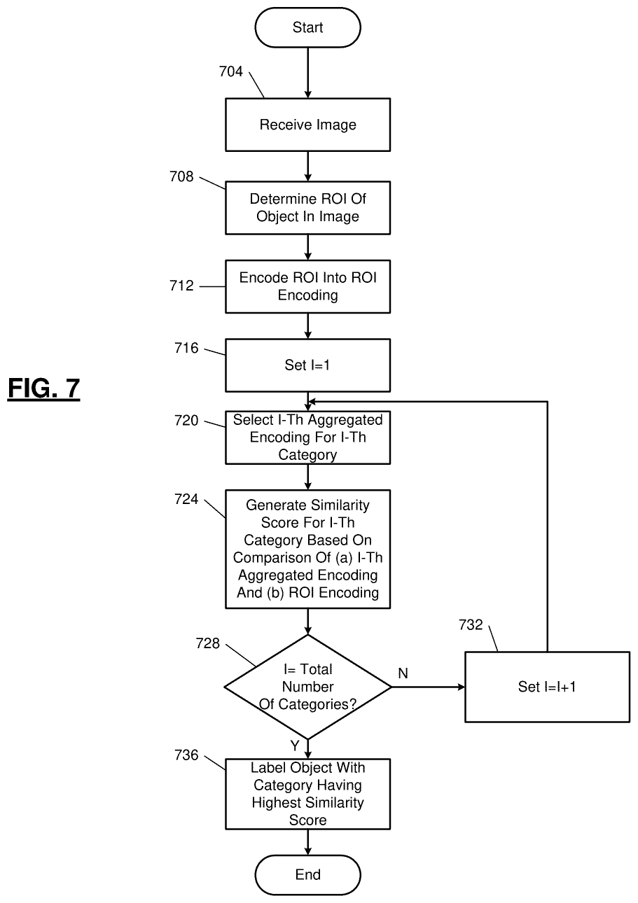

FIG. 7 is a flowchart depicting an example method of determining a category of a detected object. At 704, the ROI module 304 receives an image, such as from a camera of the robot. At 708, the ROI module 304 determines an ROI of an object in the image. At 712, the encoder module 332 encodes the ROI of the image into an ROI encoding.

At 716, the identification module 308 may set a counter value I equal to 1. At 720, the identification module 308 selects the I-th aggregated encoding for the I-th category. At 724, the identification module 308 determines a similarity score for the I-th category based on a comparison of (a) the I-th aggregated encoding and (b) the ROI encoding for the ROI including the object to be classified.

At 728, the identification module 308 determines whether the counter value I is equal to the total number of categories. If 728 is true, control may continue with 736. If 728 is false, the identification module 308 may increment the counter value I at 732 (e.g., set I=I+1), and control may return to 720 to generate a similarity score for a next category of the vocabulary.

At 736, the identification module 308 may label the object in the ROI with the category having the highest similarity score between its aggregated encoding and the ROI encoding. The example of FIG. 7 may be performed for each ROI in the input image to classify/identify each object with a category from the vocabulary. If all scores from 724 are below a threshold that may be set by the user, the ROI can be discarded and not classified to any category. The application of a threshold is arbitrary and if not set each ROI will be classified with the name of the category yielding the highest score in 724.

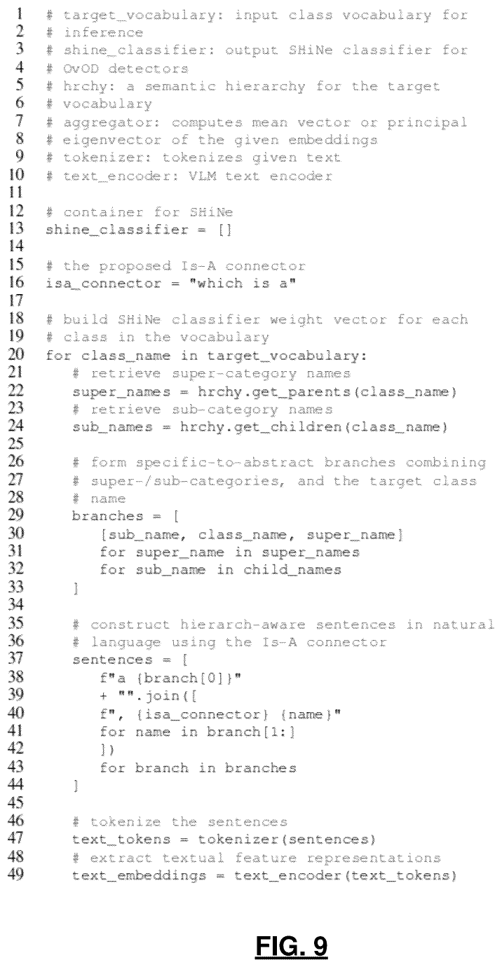

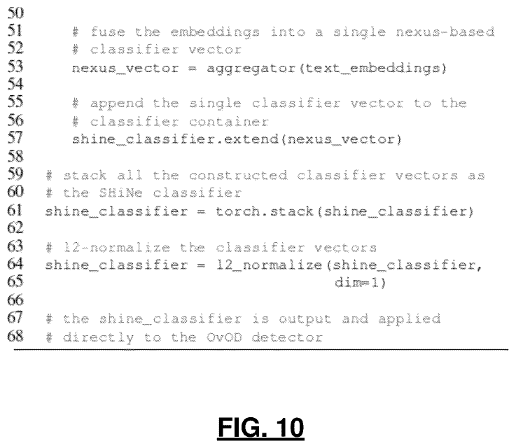

FIGS. 9 and 10 include example pseudo code for the concepts described herein.

OvOD detectors may operate using a two-stage pipeline. Stage 1 may include a region proposal network (RPN) module (e.g., ROI module 304) receiving an image and generating a set of region proposals

$${\{ ( {b}_{n , Z n} ) \}}_{n = 1}^{{N}_{b}} ,$$

where zₙ∈ [symbol] ^{D} is a D-dimensional embedding lying in a pre-trained vision-language space and bₙ∈ [symbol] ⁴ are the four coordinates of the predicted bounding box. Stage 2 may include, for each proposal, the model may optionally refine the box location bₙ←Bzₙ+bₙ, based on its content zₙ, where B∈ [symbol] ^{4×D} is a projector learned on the training dataset. Then, given a set of user-defined class names

$$C = {\{ {c}_{j} \}}_{j = 1}^{{N}_{c}} ,$$

known as the vocabulary, the model assigns a class label to each object proposal as:

$${y}_{n} = arg {max}_{c ∈ C} \{ {ε}_{txt} ( T ( c ) ) \cdot {z}_{n} \} \qquad ( A )$$

where εₜₓₜ is the frozen text encoder, T(⋅) is a natural language prompt such as “a {Class Name}” to embed the class name, and zₙ is the visual representation of the region in the joint image/text space. When training the OvOD detector, εₜₓₜ is frozen, and the model learns to align the visual features zₙ with their corresponding text representations εₜₓₜ(T(cₙ)), where cₙ is the ground-truth class name of the object in the bounding box bₙ.

Pre-trained OvOD models allow users to freely specify a set of classes C as the vocabulary—that may contain classes seen at training (base) and also unseen (novel) classes—that can differ from the training class set (hence, an “open” vocabulary), and use it at test time to label classification proposals via Eq. (A) above.

To improve OvOD detectors, the vocabulary adapter module 350 (FIG. 3) actively adapts the vocabulary C to the input image by eliminating distracting classes (classifications that are irrelevant to its semantic interpretation. Removing such classes reduces ambiguities and improves the recognition quality of the detected regions. The vocabulary adapter module 350 therefore enhances operation of the OvOD detector.

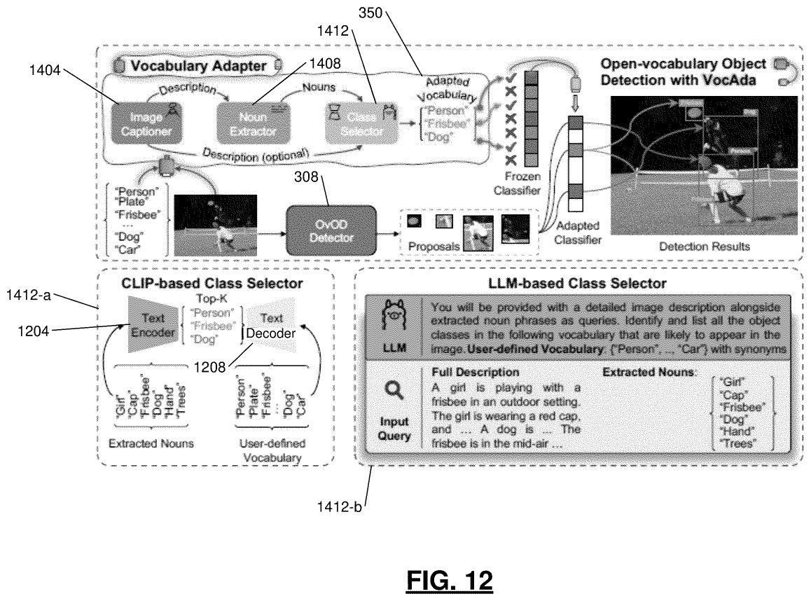

As shown in FIG. 12, given an input image I and a user-defined vocabulary C, the vocabulary adapter module 350 runs in parallel with the detector (e.g., the identification module 308) and refines the full vocabulary set C to a subset \tilde{C}_{I}⊂C by identifying visible classes in the current image and discarding irrelevant classes. Subsequently, this guides the detection process to only focus on the subset of categories by modifying the class set in Eq. (A) as:

$${y}_{n} = arg {max}_{c ∈ \tilde{{C}_{I}}} \{ {ε}_{txt} ( T ( c ) ) \cdot {z}_{n} \} \qquad ( B )$$

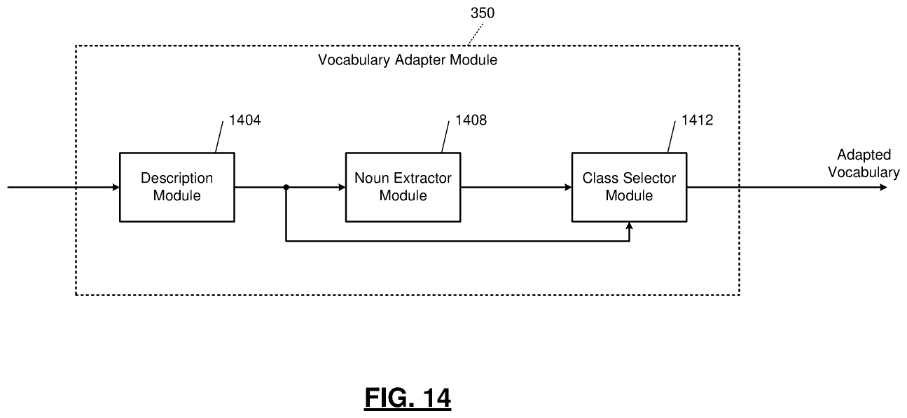

FIG. 14 includes a functional block diagram of an example implementation of the vocabulary adapter module 350. As illustrated in FIG. 14 and FIG. 12, the vocabulary adapter module 350 includes three sequential sub-modules: a description module 1404 (image captioner), a noun extractor module 1408 (noun extractor), and a class selector module 1412 (class selector). The description module 1404 generates a natural language description of visible object categories in the image. The noun extractor module 1408 parses the nouns in the description that represent category names in the description. Based on the class names in the user defined vocabulary, the class selector module 1412 identifies the ones of the classes of the user defined vocabulary that are in the image based on the nouns and the description. The class selector module 1412 uses only those ones of the classes as an adapted vocabulary for the OvOD detector. The adapted vocabulary may therefore include less than all of the classes of the user defined vocabulary.

The description module 1404 may include a VLM prompted to create a natural language description of the visible object categories in the input image. The noun extractor module 1408 processes the description from the description module 1404 to extract noun phrases that potentially contain object categories. The class selector module 1412 takes as input the user-defined vocabulary C, the extracted noun phrases, and optionally the description, and outputs a subset of classes \tilde{C}_{I} that are relevant to the current image and of interest to users \tilde{C}_{I}⊂C.

The description module 1404 (IC) generates an accurate and comprehensive description S_{I} of the objects that are visible in an image. In various implementations, the description module 1404 may include the VLM LLaVA-Next-7B captioner or another suitable captioner (VLM). The VLM LLaVA-Next-7B captioner is described in Liu, et al., LLaVA-NeXT: Improved reasoning, OCR, and world knowledge, Https://llava-vl.github.io/blog/2024-01-30-llava-next, 2024a, which is incorporated herein in its entirety.

To ensure comprehensive coverage of all objects in the image, the description module 1404 is prompted to list primary objects (larger, such as occupying greater than a number predetermined number of pixels or foreground) and secondary objects (small, such as less than a predetermined number of pixels or background). This prompt design effectively guides the description module 1404 to interpret and capture all objects in the scene. The full prompt is discussed further below.

In the generated description, the category information used to adapt the vocabulary can be found in the nouns. To isolate this information, the noun extractor module 1408 extracts noun phrases

$${P}_{I} = {\{ {p}_{m} \}}_{m = 1}^{{N}_{p}}$$

from the description S_{I} provided by the description module 1404. In various implementations, the noun extractor module 1408 may use the spaCy noun extractor to determine noun phrases through a pipeline that includes tokenizing the text, assigning part-of-speech tags, and performing dependency parsing to analyze the grammatical structure. Another suitable noun extractor may be used. The spaCy noun extractor is described in M. Honnibal, et al., spaCy: Industrial strength Natural Language Processing in Python, 2020, which is incorporated herein in its entirety.

The noun extractor module 1408 may extract noun phrases as n-grams to include informative adjectives that help clarify the semantic meaning in the current context, such as “plastic containers” instead of just “containers”, thereby facilitating the subsequent selection.

The extracted noun phrases P_{I} are the objects visible in the image. To identify and select categories from the user-defined vocabulary C, based on the noun phrases, the class selector module 1412 identifies a subset of classes \tilde{C}_{I}⊂C that are relevant to the current image and discards the other distracting classes C\\tilde{C}_{I}. Two examples for the class selector module 1412 are provided, but the present application is also applicable to other class selectors. The two examples are illustrated on the bottom of FIG. 12 by 1412-a and 1412-b.

In the first example 1412-a, the class selector module 1412 is CLIP based. The class selector module 1412 embeds the extracted noun phrases P_{I} and the vocabulary C into a textual representation space using an encoder module 1204. In various implementations, the encoder module 1204 may be a text encoder such as the CLIP ViT-L/14 text encoder or another suitable text encoder. The CLIP ViT-L/14 text encoder is described in A Radford et al., Learning Transferrable Visual Models from Natural Language Supervision, in ICML, 2021, which is incorporated herein in its entirety. For each noun phrase pₘ∈P_{I}, the class selector module 1412 (e.g., a selection module) may select the top-k most similar classes \tilde{C}ₚₘ={\tilde{c}₁, . . . , \tilde{c}ₖ} from the user defined vocabulary C based on their text similarity and use them as the adapted vocabulary \tilde{C}_{I}=∪_{pm∈P1}\tilde{C}pₘ. k is an integer greater than or equal to 1. In various implementations, k may be equal to 1. Discussion of different values of k is provided below. A decoder module 1208 decodes the selections into text.

In the second example 1412-b, the class selector module 1412 includes a large language model (LLM). Although the CLIP-based example 1412-a can effectively match the extracted noun phrases to the corresponding classes in the vocabulary, its word-to-word matching mechanism can be influenced by ambiguous nouns or class names. For example, when pₘ=“Bat” is extracted from an image of “a baseball player using a bat to hit a ball”, and both “Bat” (the animal) and “Baseball Bat” coexist in C, the former scores a higher similarity than the latter, while not being appropriate in this case. Therefore, the second example 1412-b leverages the explicit context-aware mechanism and reasoning power of an LLM. In this example, an LLM may be instantiated by embedding a task instruction and the vocabulary C, enriched with synonyms, into its system prompt. These synonyms, queried from an LLM in advance, help the system recognize classes phrased in different ways, such as “TV” vs. “Television”. This may improve selection quality. During inference, the LLM processes the full description S_{I} and the extracted nouns P_{I} as input and automatically proposes the subset \tilde{C}_{I} from the user-defined vocabulary C. In various implementations the Llama3-8B LLM or another suitable LLM may be used. The Llama3-B8 LLM is described in the publication titled Introducing Meta Llama 3: The most capable openly available LLM to date, https://ai.meta.com/blog, 2014, which is incorporated herein in its entirety.

Detection performance can be improved when the vocabulary is well-adapted to the given image. Discarding non-relevant (distracting) classes from the user defined vocabulary improves detection performance. The vocabulary adapter module 350 alleviates confusion by adapting the vocabulary to the input image based on its interpretation of the semantic context. Even when the vocabulary adapter module 250 does not lead to a correct detection, at least it avoids a mis-classification of objects.

Different variants are defined by different choices for the class selector module 1412. In addition to the LLM-based example and the CLIP-based example, the text encoder may be replacing with a different text encoder, such as the Sentence-BERT text encoder. The Sentence-BERT text encoder is described in N. Reimers, et al., Sentence-bert: sentence embeddings using Siamese bert networks, in EMNLP, 2019, which is incorporated herein in its entirety. The LLM based example may have a highest performance. The LLM may help in accurately identifying relevant categories by interpreting the rich semantic context provided by the description. The CLIP based example and the other examples, however, also increase performance. The CLIP text encoder has strong capabilities for measuring semantic similarity from a visual perspective.

Given an image I and a vocabulary C, we define the classes from C that are present in I as TPs (True Positives). A well-adapted vocabulary e \tilde{C}_{I} should meet two conditions: minimize the number of relevant classes that are missed, FNs (False Negatives); and minimize the number of irrelevant categories included, FPs (False Positives). A precision metric may be defined as Precision=TPs/(TPs+FPs) and a recall metric may be defined as Recall=TPs/(TPs+FNs). The LLM based example may have a higher provision than other examples as it may better remove distracting classes. The CLIP-based example may have a higher recall meaning may miss fewer relevant classes.

Increasing k allows us to expand the size of \tilde{C}_{I} thereby reducing FNs but risking an increase in FPs. Increasing k may decrease the gain, which may suggest that the benefit of missing fewer relevant classes comes at the cost of increasing distracting classes.

Including synonyms for class names in the user-defined vocabulary when prompting the LLM-based example further improves performance. Without synonyms some large and obvious objects like “Couch” or “TV” may be missed by the LLM-based example even though they were included in the image descriptions. This may occur because these categories were phrased differently in image captions (e.g., “Sofa” or “Television”) and, hence, the LLM-based example processed them as not relevant and discarded them from the adapted vocabulary. Including synonyms as cues in the system prompt of the LLM prevents this erroneous filtering, resulting in superior performance.

Using synonyms in the CLIP-based example may involve querying an LLM at for each noun phrase, which may add extra computational cost. Which LLM is used in the LLM based example may only minimally change performance.

FIG. 13 includes an example input image and a query to list all primary and secondary objects in the image. Ground truth classes (categories) from the user defined vocabulary are provided at the bottom. Some regions of the image are enlarged for better visibility but the original input image is used, not the enlarged regions. Examples of primary and secondary objects detected and classified by the vocabulary adapter module 350 are provided in FIG. 13.

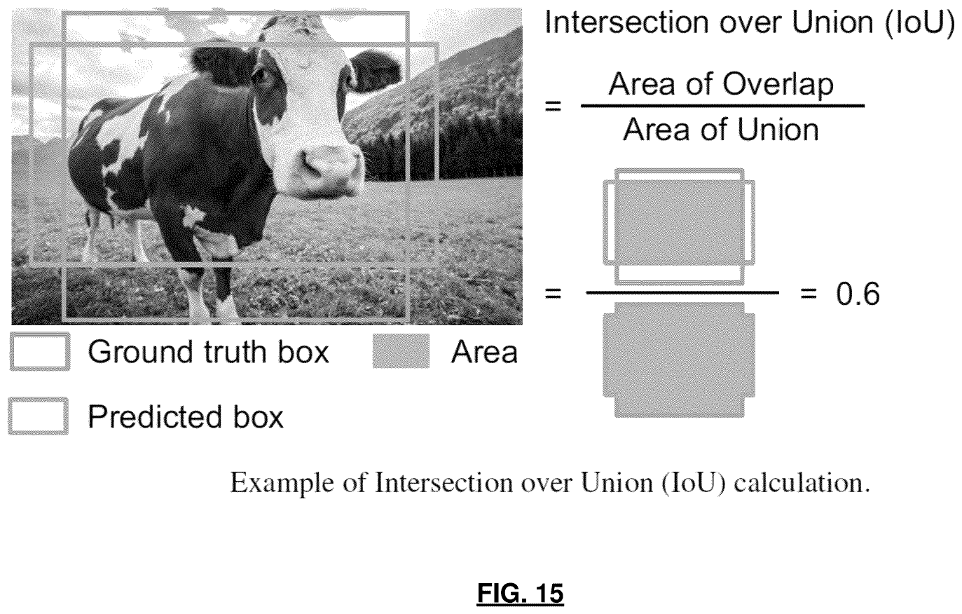

FIG. 15 includes an example image with a predicted bounding box and a ground truth bounding box around an object. As illustrated, the Intersection over Union (IoU) is the ratio of their intersection area to their union area. For each object class, predictions may be sorted by their confidence scores in descending order, and Average Precision (AP) may be calculated as the area under the precision-recall curve. This combines precision and recall to provide a single performance measure for detection tasks.

Mean Average Precision (mAP) is the mean of the AP values, averaged across novel (unseen), base (seen), or all classes, denoted by APnovel, APbase, and APall, respectively. AP50 refers to mAP when IoU is considered with a threshold of 0.5. Otherwise, AP values are computed for thresholds from 0.5 to 0.95 in steps of 0.05 and then averaged.

Taking the calculation of AP50 as an example, the IoU for each predicted bounding box and ground truth pair may be computed. A prediction is considered a True Positive (TP) if: i) its IoU is 0.50 or higher, and ii) its predicted class label matches the ground truth; otherwise, it's a False Positive (FP). Detections are sorted by confidence scores in descending order, and for each prediction, its IoU and class label are evaluated against the ground truth. Precision and recall are calculated at each detection: precision is the ratio of TPs to the total number of predictions (TPs+FPs), and recall is the ratio of TPs to the total number of ground truth objects (TPs+FNs), as discussed above. These values are used to plot the precision-recall curve, and the area under this curve represents the AP50 measurement. The final AP50 is averaged across all evaluated classes, summarizing the model's performance in terms of both localization and classification for the test dataset.

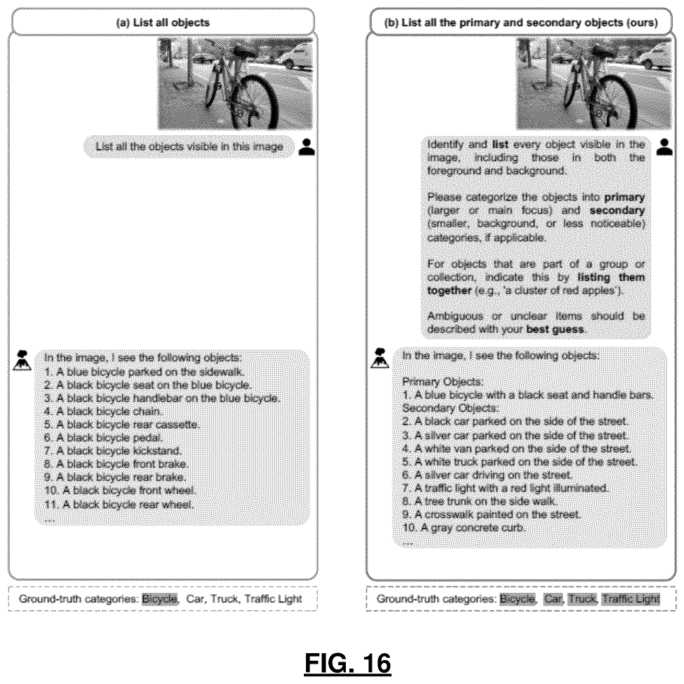

Regarding prompts, the comprehensiveness of the description generated by the description module 1404 is crucial for the subsequent functions of the vocabulary adapter module 350. The image description should capture as many categories/classes present in the current image as possible. Even state-of-the-art VLMs often neglect background objects in images, focusing on more prominent foreground objects when prompted with a simple prompts such as “List all the objects visible in this image”. For instance, as shown in left image of FIG. 16, although the cars and trucks in the background are clearly visible, the description could only describe the foreground object “bicycle”. To address this, as shown on the right image of FIG. 16, the present application involves prompting the description module 1404 to not only list all visible objects but also categorize them into primary and secondary objects. This effectively guides the description module 1404 to comprehensively describe both large and focused foreground objects (primary) and small and background objects (secondary), such as “Traffic Light” on the right image of FIG. 16.

The right image of FIG. 16 illustrates an example prompt to the description module 1404 to describe the image. The description module 1404 creates textual descriptions of the objects visible in the image according to the prompt.

First, the prompt may ask the description module 1404 to list a group of objects together (e.g., “a cluster of red apples”) instead of one by one. This technique prevents the description module 1404 from generating repetitive patterns, which are lengthy and not useful for the following steps. The goal of the description module 1404 is to comprehensively capture object categories likely to appear in the current images. Therefore, the description module 1404 may be prompted to provide “best guesses” for unclear items. This may force the description module 1404 to reason possible objects that might be present in the image based on its interpretation. While this might introduce extra noise, the class selector module 1412 can alleviate most of them especially if they are unrelated to the global image context.

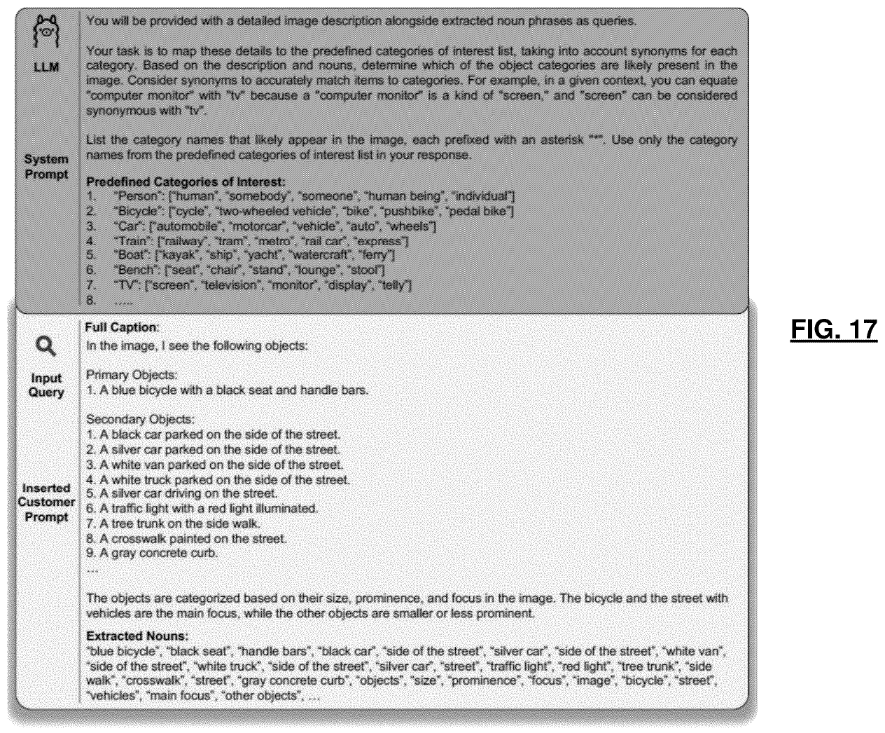

Regarding prompting an LLM as Class Selector (CS), FIG. 17 includes an illustration of a complete system and customer prompts used for the LLM-based example. The class selector module 1412 may instantiate a LLM agent, such as the Llama3-8B (Meta, 2024), with a system prompt that includes a task instruction and the user-defined vocabulary with their synonyms. The task instruction specifies the input query, the generated image caption S, provided by the class selector module 1412 and the corresponding extracted noun phrases P, from the noun extractor module 1408, that the LLM will receive during inference. The prompt guides the LLM with a detailed task description, which is to select relevant categories likely to appear in the image from the embedded user-defined vocabulary based on the input, taking also synonyms into consideration. Subsequently, the LLM is instructed/prompted with the output format of the selected categories (prefixing each category name with an asterisk “*”) for easier post parsing. This LLM instantiation is conducted before large scale inference.

During inference, the LLM-based class selector module 1412 takes the complete image description S, and the corresponding noun phrases P_{I} as the customer input without any additional instructions and automatically outputs a selected category set as the adapted vocabulary \tilde{C}_{I}. FIG. 17 therefore includes complete prompts used the LLM based example of the class selector module 1412. The top block of FIG. 17 includes a system prompt that includes the user defined categories/classes and a set of synonyms and the task instruction. The synonyms guide the LLM to select from the category list the ones that are relevant given as input an image description and the set of extracted noun phrases. This system prompt is used to instantiate the LLM agent as the class selector module 1412. The bottom block of FIG. 17 illustrates that during inference, the full image description, (S_{I} provided by the description module 1404) alongside the extracted noun phrases (P_{I} from the noun extractor module 1408) are fed to the system as customer prompt input. Subsequently, the LLM automatically proposes the selected category names based on this input.

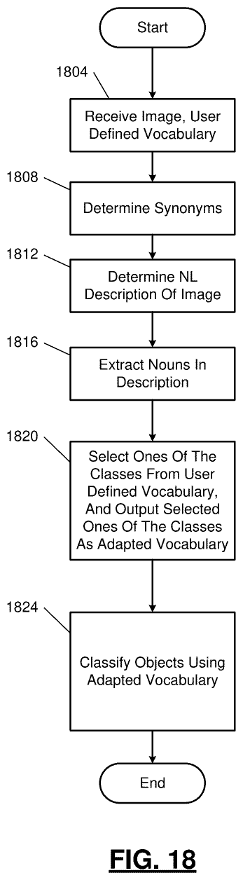

FIG. 18 includes a flowchart depicting an example method of generating an adapted vocabulary from a user-defined vocabulary and performing object detection. Control begins with 1804 where the vocabulary adapter module 350 receives an input image upon which object detection is to be performed by the object detection module 150 and a user-input set of classifications (user defined vocabulary). At 1808 the vocabulary adapter module 350 (e.g., a synonym module) may determine one or more synonyms for each classification in the user defined vocabulary.

At 1812 the vocabulary adapter module 350 (e.g., the description module 1404) determines the natural language description of the image, as described above. The noun extractor module 1408 extracts the nouns (grammatical) from the description at 1816 as discussed above.

At 1820, the class selection module 1412 selects ones of the classes from the user-defined vocabulary based on the nouns and the description. The ones of the classes that are selected are used as the adapted vocabulary. At 1824, the object detection module 150 detects and classifies objects in the image using the adapted vocabulary as described above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The embodiments include a robot system with a camera that captures an input image; an object detection system; and a control module that selectively actuates an actuator of the robot based on an object being identified as in the category by the object detection system as described above. In one embodiment, the object detection system includes: a means for, for a category of a vocabulary of objects, retrieving a hierarchy including at least: a sub-category that is more specific than the category; and a super-category that is less specific than the category; a means for generating a set of sentences for the category that describe the hierarchical relationship between sub-category, super-category, and the category; a means for encoding the sentences into encodings, respectively, for the category; a means for generating an aggregated encoding for the category by aggregating the encodings of the category; and a means for selectively identifying an object included in a region of interest of an input image as being in the category based on a comparison of (a) an encoding of the region of interest and (b) the aggregated encoding for the category.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCamI, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An object detection system, comprising:
a category module configured to, for a category of a vocabulary of objects, retrieve a hierarchy including at least:
a sub-category that is more specific than the category; and
a super-category that is less specific than the category;
a sentence module configured to generate a set of sentences for the category that describe the hierarchical relationship between sub-category, super-category, and the category;
an encoder module configured to encode the sentences into encodings, respectively, for the category;
an aggregator module configured to generate an aggregated encoding for the category by aggregating the encodings of the category; and
an identification module configured to selectively identify an object included in a region of interest of an input image as being in the category based on a comparison of (a) an encoding of the region of interest and (b) the aggregated encoding for the category.

2. The object detection system of claim 1 wherein the hierarchy includes at least two sub-categories that are more specific than the category.

3. The object detection system of claim 1 wherein the hierarchy includes at least two super-categories that are less specific than the category.

4. The object detection system of claim 1 wherein the hierarchy further includes at least one sub sub-category that is more specific than the sub-category.

5. The object detection system of claim 1 wherein the sentence module is configured to generate the sentences and describe the hierarchical relationship between each sub-category, super-category, and the category using an Is-A connector.

6. The object detection system of claim 1 wherein the vocabulary is defined based on at least one of user input and input received in response to querying a large language model.

7. The object detection system of claim 1 wherein the aggregator module is configured to generate the aggregated encoding for the category using a mathematical mean of the encodings.

8. The object detection system of claim 1 wherein the encoder module is configured to encode the sentences using a visual language model (VLM) text encoder.

9. The object detection system of claim 1 wherein the aggregator module is configured to generate the aggregated encoding for the category using a principal eigenvector.

10. The object detection system of claim 1 wherein:
the category module is further configured to, for a second category of the vocabulary of objects, determine a second hierarchy including at least:
a second sub-category that is more specific than the second category; and
a second super-category that is less specific than the second category;
the sentence module is further configured to generate a second set of sentences for the second category that describe the hierarchical relationship between second sub-category, second super-category, and the second category;
the encoder module is further configured to encode the second sentences into second encodings, respectively, for the second category;
the aggregator module is further configured to generate a second aggregated encoding for the second category by aggregating the second encodings of the second category; and
the identification module is further configured to selectively identify the object included in the region of interest of the input image as being in the second category based on a comparison of (a) the encoding of the region of interest and (b) the second aggregated encoding for the second category.

11. The object detection system of claim 10 wherein the identification module is further configured to:
generate a first similarity score for the category based on a comparison of (a) the encoding of the region of interest and (b) the aggregated encoding for the category; and
generate a second similarity score for the second category based on a comparison of (a) the encoding of the region of interest and (b) the second aggregated encoding for the second category; and
determine whether to identify the object included in the region of interest as being in the category or the second category based on the similarity scores.

12. The object detection system of claim 11 wherein the identification module is configured to identify the object included in the region of interest as being in the category when the first similarity score is greater than the second similarity score.

13. The object detection system of claim 12 wherein the identification module is configured to identify the object included in the region of interest as being in the second category when the second similarity score is greater than the first similarity score.

14. The object detection system of claim 11 wherein the identification module is configured to generate the first and second similarity scores using cosine similarity.

15. The object detection system of claim 11 wherein the identification module is configured to generate the first and second similarity scores using the dot product function.

16. The object detection system of claim 1 wherein the hierarchy is generated by querying a large language model (LLM).

17. The object detection system of claim 1 wherein the input image is the region of interest.

18. A robot system, comprising:
a camera that captures the input image;
the object detection system of claim 1; and
a control module that selectively actuates an actuator of the robot based on the object being identified as in the category.

19. The robot system of claim 18 wherein the actuator includes an electric motor.

20. (canceled)

21. An object detection system, comprising:
a means for, for a category of a vocabulary of objects, retrieving a hierarchy including at least:
a sub-category that is more specific than the category; and
a super-category that is less specific than the category;
a means for generating a set of sentences for the category that describe the hierarchical relationship between sub-category, super-category, and the category;
a means for encoding the sentences into encodings, respectively, for the category;
a means for generating an aggregated encoding for the category by aggregating the encodings of the category; and
a means for selectively identifying an object included in a region of interest of an input image as being in the category based on a comparison of (a) an encoding of the region of interest and (b) the aggregated encoding for the category.

22. An object detection system, comprising:
a vocabulary adapter module configured to:
receive an image and a first set of classifications;
determine a natural language description based on the image;
extract grammatical nouns from the natural language description;
select ones of the classifications of the first set based on the grammatical nouns;
generate a second set of classifications: including the selected one of the classifications of the first set; and not including non-selected ones of the classifications of the first set; and
an identification module configured to selectively identify an object included in a region of interest of the image using the second set of classifications.

23. The object detection system of claim 22 wherein the identification module is configured to identify the object included in the region of interest as being associated with one of the classifications of the second set based on a comparison of (a) an encoding of the region of interest and (b) an aggregated encoding for the one of the classifications of the second set.

24. The object detection system of claim 22 wherein the vocabulary adapter module is configured to select the ones of the classifications of the first set further based on the natural language description.

25. The object detection system of claim 22 wherein the vocabulary adapter module includes a description module configured to determine a natural language description based on the image,
wherein the description module includes a visual language model (VLM) that generates the natural language description.

26. The object detection system of claim 22 wherein the vocabulary adapter module is configured to generate the second set of classifications further based on synonyms of the classifications of the first set.

27. The object detection system of claim 22 wherein the vocabulary adapter module includes a class selector module configured to select the top-k most similar ones of the classifications of the first set to the grammatical nouns based on text similarity; and select the top-k most similar ones of the classifications of the first set as the classifications of the second set of classifications.

28. The object detection system of claim 22 wherein the vocabulary adapter module includes a large language model (LLM) configured to generate the second set of classifications.

29. The object detection system of claim 28 wherein the LLM is configured to generate the second set of classifications further based on synonyms of the classifications of the first set.

30. The object detection system of claim 28 wherein the LLM is configured to generate the second set of classifications further based on a prompt to identify and list every object visible in the image including both a foreground of the image and a background of the image.

31. The object detection system of claim 22 wherein the second set of classifications includes a few number of classifications than the first set of classifications.

32-41. (canceled)

42. A robot system, comprising:
a camera that captures the input image;
the object detection system of claim 22; and
a control module that selectively actuates an actuator of the robot based on the object being identified as in the category.

43. The robot system of claim 42 wherein the actuator includes an electric motor.
